(19) United States
(12) Patent Application Publication
(10) Pub. No.: US 2025/0100164 A1
(43) Pub. Date: Mar. 27, 2025

(54) GRIPPING SYSTEM FOR GRIPPING A LABEL ROLL

(71) Applicant: KRONES AG, Neutraubling (DE)

(72) Inventor: Martin WAGNER, Regensburg (DE)

(21) Appl. No.: 18/896,032

(22) Filed: Sep. 25, 2024

(30) Foreign Application Priority Data
Sep. 25, 2023 (DE) 10 2023 125 949.0

(51) Int. Cl. B25J 15/00; B25J 9/14; B25J 9/16; B25J 13/08

(52) U.S. Cl. CPC B25J 15/0047; B25J 9/144; B25J 13/088; B25J 15/0028

(57) ABSTRACT

A gripping system for gripping a label roll with a ring-shaped roll core. The gripping system has an inner gripper which has a plurality of inner clamping jaws which are arranged distributed in a circumferential direction around a central axis of the gripping system and can be moved radially with respect to the central axis to grip the inside of the label roll on an inner circumferential face of the annular roll core. The gripping system further has at least one distance sensor, which is arranged for detecting a distance between the gripping system and the label roll.

### CROSS REFERENCE TO RELATED APPLICATIONS

This application claims the benefit under 35 U.S.C. § 119 (a) of German Patent Application No. DE 10 2023 125 949.0, filed Sep. 25, 2023 entitled GRIPPING SYSTEM FOR GRIPPING A LABEL ROLL, and whose entire disclosure is incorporated by reference herein.

### TECHNICAL FIELD

The invention relates to a gripping system for gripping a label roll. The invention also relates to an apparatus for handling a label roll with such a gripping system. The invention also relates to a method for operating such a gripping system or apparatus.

### TECHNICAL BACKGROUND

A container treatment plant can comprise a labeling device for labeling containers. For example, the labeling device can label the containers with labels from a label roll (roll of label material).

Traditionally, the label rolls are refilled manually by an operator. The user may have to perform additional tasks, such as cutting the label tape to the correct position, applying double-sided adhesive tape to the label tape, or inserting the label tape into an automatic gluing.

DE 10 2021 125 133 A1 describes a mobile robot, a supply system, and a method for changing label rolls on a labeling unit for labeling containers. The mobile robot accordingly comprises a vehicle unit for changing locations of the robot and a manipulator unit with a multi-axle manipulator and an associated end effector for manipulating label rolls. Since the end effector is designed to grip the outer circumference of the label rolls and emptied roll cores of label rolls so as to carry them, ergonomically problematic work steps when refilling label rolls can be accomplished exclusively by machine with a high degree of precision and in a material-saving manner.

A disadvantage of the manipulator unit of DE 10 2021 125 133 A1 may be that the clamping force is relatively low due to the small cylinders and no actual maintenance of the clamping force is disclosed. The gripper jaws are only locked in position. It is not possible to center the label roll precisely with the manipulator unit because, for example, the gripper jaws are not mechanically coupled. The manipulator unit is very large in diameter, namely larger than the diameter of the label roll. To transport the label roll from a pallet to a roll receptacle, the clamping position must be changed from the inner to the outer gripper and the roll must be deposited in between, which has a negative effect on the cycle time and process reliability. Clamping the label roll exclusively on the outer circumference at times could damage the label tape, and a secure hold of the label roll is questionable. The manipulator unit cannot prevent the label roll from telescoping. In addition, opened label rolls with loose label tape cannot be handled.

The invention is based on the object of creating an improved technique for handling label rolls for loading a labeling device. Preferably, at least some of the described disadvantages of the prior art can be overcome.

### SUMMARY OF THE INVENTION

The object is achieved by the features of independent claim 1. Advantageous developments are specified in the dependent claims and the description.

One aspect of the present disclosure relates to a (e.g. pneumatic) gripping system for gripping a label roll having a ring-shaped roll core. The gripping system has a, preferably pneumatic, inner gripper, preferably an inner centric gripper, which has several (e.g. three) inner clamping jaws which are arranged distributed (e.g. evenly) in a circumferential direction around a central axis of the gripping system and can be moved radially with respect to the central axis for inner gripping of the label roll on an inner circumferential face of the annular roll core. The gripping system also has at least one distance sensor (e.g. ultrasonic sensor, diffuse sensor, laser sensor or capacitive sensor), which is arranged to detect a distance between the gripping system and the label roll.

Advantageously, inner gripping can be the safest and most reliable method of gripping a label roll for a dynamic handling operation. Damage to the label roll can be avoided by tensioning it on the roll core. Advantageously, the detected distance or distances can be used to determine a position of the (not yet gripped) label roll relative to the gripping system. Preferably, this enables fine positioning of the inner gripper relative to the label roll and/or the roll core in order to be able to grip the label roll particularly securely. If the thickness (height) of the label roll to be gripped is also known, the fine positioning of the inner gripper can enable an adapted insertion depth of the inner gripper into the roll core, whereby both very narrow and very thick label rolls can be gripped particularly securely on the inside.

Preferably, the inner clamping jaws can be aligned parallel to the central axis.

In one embodiment example, the at least one distance sensor has a plurality of distance sensors, which are preferably arranged in a circumferential direction around the central axis (e.g. evenly), preferably alternating with the plurality of inner clamping jaws. Advantageously, the multiple distance sensors can enable a relative orientation of the label roll to the gripping system to be determined. This allows the inner gripper to be moved into an optimum alignment relative to the label roll for the inner gripping, namely preferably parallel to the ring-shaped roll core/coaxially inside the ring-shaped roll core.

In a further embodiment example, the at least one distance sensor can be aligned parallel to the central axis. This allows the distance parallel to the central axis to be detected.

In one embodiment, the plurality of inner clamping jaws are mechanically coupled to one another for joint, preferably synchronous, radial movement, preferably by means of a positively driven transmission, particularly preferably by means of a positively driven wedge-hook transmission. Advantageously, the joint, preferably synchronous, movement can enable centric gripping of the roll core and thus of the label roll.

In a further embodiment, the plurality of inner clamping jaws each have a (e.g. curved) contact face for contacting the inner circumferential face of the roll core, wherein the contact faces are profiled, preferably corrugated or serrated. Advantageously, profiling on the contact faces can enable the inner clamping jaws to press into soft cardboard roll cores in particular and thus reliably prevent the roll core from slipping.

In a further embodiment, the multiple inner clamping jaws are each elastically preloaded (e.g. by means of a spring) radially outwards with respect to the central axis. Advantageously, the elastic pre-tensioning of the inner clamping jaws can enable the inner clamping jaws to be tensioned outwards even when there is no compressed air. Preferably, this ensures that the label roll is held securely in the event of a fault, e.g. in the event of a compressed air failure.

In an embodiment example, the inner gripper has a, preferably pneumatic, pressure control valve for adjusting a gripping force (clamping force) of the inner gripper, preferably by adjusting a counterforce or supporting force to an (or the) elastic pretension of the plurality of inner clamping jaws. Advantageously, the adjustment of the gripping force by means of the pressure control valve can support the use of the gripping system as a universal gripping system, as the gripping force can be adapted to label rolls of different sizes and therefore weights. This reduces the risk of the roll core being deformed and damaged by excessive gripping force, particularly in the case of narrow or opened (partially unwound) label rolls.

In one embodiment, the inner gripper has a, preferably pneumatic, non-return valve for holding a gripping force (clamping force) of the inner gripper. In the event of a fault, the gripping force can be maintained by means of a non-return valve until the robot comes to a standstill. As an option, the secure clamping of the label roll can then be further ensured by the elastic pre-tensioning, even if a creeping pressure loss would occur through the non-return valve.

In a further embodiment example, the gripping system further has an outer gripper, preferably pneumatic, with a plurality of (e.g. four or six) outer gripping jaws which are arranged on the outside of the plurality of inner gripping jaws in a circumferential direction around the central axis (e.g. evenly) and are movable radially with respect to the central axis to secure the label roll to an outer circumferential face of the label roll. An additional external clamping of the label rolls can be made possible by means of the external gripper. Narrow label rolls in particular can tend to telescope, e.g. if they are only tensioned at the roll core and are exposed to dynamic forces during fast robot movements. In order to increase process reliability and reduce the cycle time for roll changes, the gripping system can therefore be equipped with the external gripper, which can improve the handling of narrow label rolls in particular. Since the label roll continues to be tensioned over the roll core by means of the inner gripper and preferably only a comparatively small force is applied to the label roll via the outer gripper, the risk of damage to the label roll can be minimized. The external gripper can also be used to handle label rolls that have already been opened and where the end of the tape is no longer secured (e.g. with adhesive tape) but is loose. This is also an advantageous option for automated sort changeover, as the gripping system can secure opened label rolls, remove them from roll plates and transport them to a reprocessing station, for example.

In one embodiment, the multiple outer clamping jaws are rounded and/or made of an elastically compressible material and/or made of a softer material than the inner clamping jaws. Advantageously, a rounded shape of the clamping jaws or a soft and/or elastic material of the outer clamping jaws can help to prevent damage to the label roll as far as possible.

In a further embodiment, the maximum gripping force (clamping force) that can be exerted by the outer gripper is less than the maximum gripping force (clamping force) that can be exerted by the inner gripper. The advantage of this is that the label roll is actually only secured on the outside, while the actual gripping is fedthrough by the inner gripper.

In one embodiment, the multiple outer clamping jaws are mechanically coupled to the multiple inner clamping jaws for radial movement with respect to the central axis, and the outer clamping jaws can also be moved radially with respect to the central axis independently of the multiple inner clamping jaws. Alternatively or additionally, the outer gripper is mounted on the outside of the several inner clamping jaws. Alternatively or additionally, the multiple outer clamping jaws can be moved parallel to the central axis, preferably in and out. Advantageously, the mechanical coupling and, particularly preferably, the direct mounting of the outer gripper on the inner clamping jaws can ensure a direct flow of force during clamping. The outer gripper can therefore be designed to be particularly rigid and lightweight.

In a further embodiment, the plurality of outer clamping jaws have a plurality (e.g. two or three) of first outer clamping jaws and a plurality (e.g. two or three) of second outer clamping jaws. The plurality of first outer clamping jaws are arranged on the outside of the plurality of inner clamping jaws in a circumferential direction around the central axis (e.g. evenly). The plurality of second outer clamping jaws are arranged on the outside of the plurality of first outer clamping jaws in a circumferential direction around the central axis (e.g. evenly). Advantageously, a configuration with first (inner) outer clamping jaws and second (outer) outer clamping jaws can enable a very large clamping range for clamping a wide variety of label roll diameters with a compact and simple design at the same time. Preferably, the external gripper can therefore secure all standard label roll diameters up to 600 mm on the outside.

In one embodiment, the outer gripper has a plurality of radial lift cylinders that are connected to the outer clamping jaws for moving the plurality of outer clamping jaws radially with respect to the central axis. Preferably, one of the plurality of radial lift cylinders can be mounted on the outside of one of the plurality of inner clamping jaws. Advantageously, the connection, preferably the direct mounting, of the radial lift cylinders on the outside of the inner clamping jaws ensures a direct flow of force during clamping. As already mentioned, the outer gripper can therefore be designed to be particularly rigid and lightweight.

In another embodiment example, the multiple radial lift cylinders each have a displacement sensor. Advantageously, the outer diameter of the label roll can be checked by means of the position measuring sensors when the label roll is clamped on the outside. It is also possible to check the correct positioning of the outer clamping jaws if the outer diameter of the label roll is known. In addition, telescoping of particularly poorly wound label rolls can be advantageously detected if the outer diameter of the roll changes downwards due to slipping/unwinding of the label tape. Then, for example, a warning can be issued and, for example, an operator intervention can be triggered.

In one embodiment, one each of the plurality of radial lift cylinders is connected to two each of the outer clamping jaws for radially moving these two outer clamping jaws (e.g. one of the first outer clamping jaws and one of the second outer clamping jaws). This has the advantage of simplifying the design of the external gripper and making the external gripper more compact.

In a further embodiment, the outer gripper has a plurality of axial stroke cylinders which are connected to the outer clamping jaws for axially moving the plurality of outer clamping jaws parallel to the central axis, wherein preferably one of the plurality of axial stroke cylinders is connected to each of the outer clamping jaws for axially moving this one outer clamping jaw. Advantageously, the axial retraction and extension allows the outer clamping jaws to be retracted when they are not needed, for example when they would interfere with inner gripping or when they would interfere with the positioning of the gripping system. Advantageously, the axial retraction and extension can also make it possible, for example, for only certain outer clamping jaws, e.g. only the first or only the second outer clamping jaws, to engage with an outer circumferential face of the label roll.

In one embodiment, the multiple radial lift cylinders for radial movement of the multiple axial lift cylinders are connected to the multiple axial lift cylinders together with the outer clamping jaws with respect to the central axis. Preferably, one of the multiple radial lift cylinders can be connected to two of the multiple axial lift cylinders for the radial movement of these two axial lift cylinders. Alternatively or additionally, the multiple axial lift cylinders are connected between the multiple radial lift cylinders on the one hand and the outer clamping jaws on the other.

Another aspect of the present disclosure relates to an apparatus for handling a label roll having an annular roll core. The apparatus has a gripping system as disclosed herein. The apparatus further has a, preferably stationary, robot, preferably multi-axis robot, particularly preferably articulated arm robot, wherein the robot carries the gripping system as an end effector. The apparatus further has a processing device configured to operate the robot for (e.g. fine) positioning the gripping system for gripping the label roll by means of the inner gripper, depending on a distance between the label roll and the gripping system detected by the at least one distance sensor. Optionally, the processing device can also be configured to operate the robot for (e.g. fine) positioning of the gripping system for gripping the label roll by means of the inner gripper as a function of a detected or predetermined thickness of the label roll, preferably for adapting an immersion depth of the inner gripper into the roll core as a function of the thickness. Advantageously, the apparatus can make it possible to achieve the same advantages that have already been explained with reference to the gripping system.

In one embodiment example, the at least one distance sensor has several distance sensors. The processing device is further configured to:
determine an orientation of the label roll relative to the gripping system depending on the distances detected by the plurality of distance sensors, and
operate the robot for aligning the gripping system for gripping the label roll by means of the inner gripper furthermore depending on the determined alignment, preferably for parallel alignment of the several inner clamping jaws to the roll core for gripping the label roll.

As already explained, this has the advantage of enabling the label roll to be gripped particularly gently and securely, thus enabling high dynamics when handling the gripped label roll, even with a very narrow label roll.

In a further embodiment example, the gripping system or robot has a camera, preferably 2D or 3D camera, for recording the label roll, and the processing device is further configured to:
determine a position of the label roll depending on a recording of the camera and to operate the robot for (e.g. pre-) positioning the gripping system for gripping the label roll by means of the inner gripper depending on the determined position; and/or
determine the positions of several label rolls within a roll stack depending on a recording of the camera and to operate the robot for (e.g. pre-) positioning the gripper system for gripping a respective uppermost label roll of the roll stack by means of the inner gripper depending on the determined positions.

Advantageously, the camera can enable pre-positioning of the gripping system so that subsequent fine positioning is possible using the at least one distance sensor. Advantageously, the camera can also be used to rotate the gripping system around its central axis in such a manner that the outer clamping jaws are positioned so that they can enter spaces between the label rolls of one or more roll stacks. This allows external clamping to take place at the earliest possible point in time.

In one embodiment, the gripping system further has an outer gripper, preferably pneumatic, with a plurality of outer clamping jaws, which are preferably arranged on the outside of the plurality of inner clamping jaws in a circumferential direction around the central axis (e.g. evenly) and can be moved radially with respect to the central axis to secure the label roll to an outer circumferential face of the label roll. The outer gripper can have several radial lift cylinders that are connected to the outer clamping jaws for radial movement of the several outer clamping jaws with respect to the central axis. Each of the several radial lift cylinders has a displacement sensor. The processing device is further configured to:
determine a diameter of a label roll secured on the outside by means of the outer clamping jaws depending on a signal output of the displacement measuring sensors; and optionally
compare the determined diameter with a nominal diameter of the label roll to detect correct positioning of the multiple outer clamping jaws; and/or
determine the diameter several times in succession for the same label roll to detect telescoping of the label roll when the diameter is reduced.

Another aspect of the present disclosure relates to a device for labeling containers. The apparatus has a (e.g. rotary) labeling device with a labeling unit for labeling the containers. The device further has an apparatus for handling a label roll as disclosed herein. The robot is configured to automatically load a roll receptacle connected to the labeling unit with a label roll by means of the gripping system, for unwinding the respective label roll to a labeling belt for feeding it to the at least one labeling unit for labeling the containers.

Preferably, a clamping shaft of the roll receptacle and the plurality of inner clamping jaws can be shaped and/or arranged complementary to one another, preferably to enable the plurality of inner clamping jaws to plunge into spaces between clamping elements of the clamping shaft during a label roll transfer.

Another aspect of the present disclosure relates to a container treatment system (e.g., for tempering, manufacturing, cleaning, coating, testing, filling, capping, pasteurizing, labeling, printing, marking, laser marking and/or packaging containers for liquid or pasty media, preferably beverages, liquid foods or products from the pharmaceutical or healthcare industry). The container handling system may have the gripping system as disclosed herein or the apparatus as disclosed herein.

For example, the containers can be realized as bottles, cans, canisters, cartons, vials, tubes, etc.

Preferably, the term “processing device” can refer to an electronic plant (e.g., embodied as a driver circuit or with microprocessor(s) and data memory) and/or a mechanical, pneumatic, and/or hydraulic controller which can take over control tasks and/or regulation tasks and/or processing tasks, depending on the design. Although the term “control” is used herein, this can also comprise or be understood as “regulate” or “feedback-control” and/or “process.”

Another aspect of the present disclosure relates to a method of operating a gripping system as disclosed herein or an apparatus as disclosed herein, wherein the method has at least one of:
detecting at least one distance between the gripping system and a label roll by means of the at least one distance sensor;
(e.g. fine) positioning and/or aligning the inner gripper to an annular roll core of the label roll as a function of the at least one detected distance, preferably by means of a robot;
innerly gripping the label roll on an inner circumferential face of the roll core by means of the plurality of inner clamping jaws of the inner gripper after positioning and/or aligning, preferably effected by an elastic pretension of the plurality of inner clamping jaws; and optionally:
securing the innerly gripped label roll to an outer circumferential face of the label roll by means of a plurality of outer clamping jaws of an outer gripper of the gripping system; and/or
adjusting a gripping force (clamping force) of the inner gripper by means of a, preferably pneumatic, pressure control valve; and/or
aligning the inner gripper with a clamping shaft of a roll receptacle (e.g. connected to a labeling unit) during a label roll transfer between the inner gripper and the clamping shaft, preferably in such a manner that the multiple inner clamping jaws can enter spaces between clamping elements of the clamping shaft.

Advantageously, the method can enable the same advantages to be achieved as already explained with reference to the gripping system.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a perspective view of an apparatus according to an exemplary embodiment of the present disclosure;

FIG. 2 shows a perspective view of a gripping system according to an embodiment of the present disclosure; and

FIG. 3 shows a side view of the exemplary gripping system.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

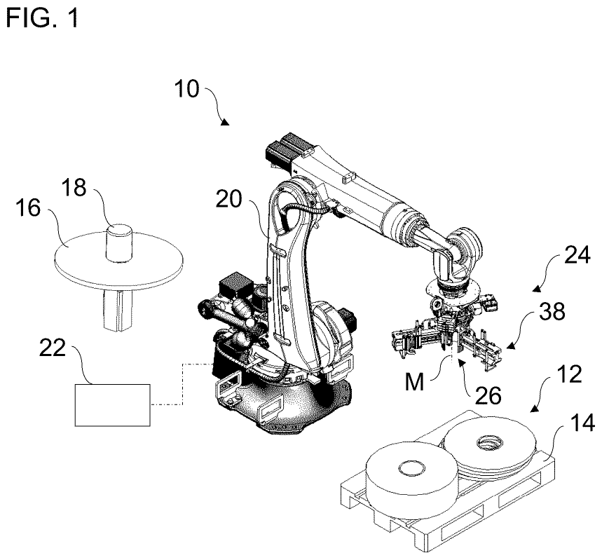

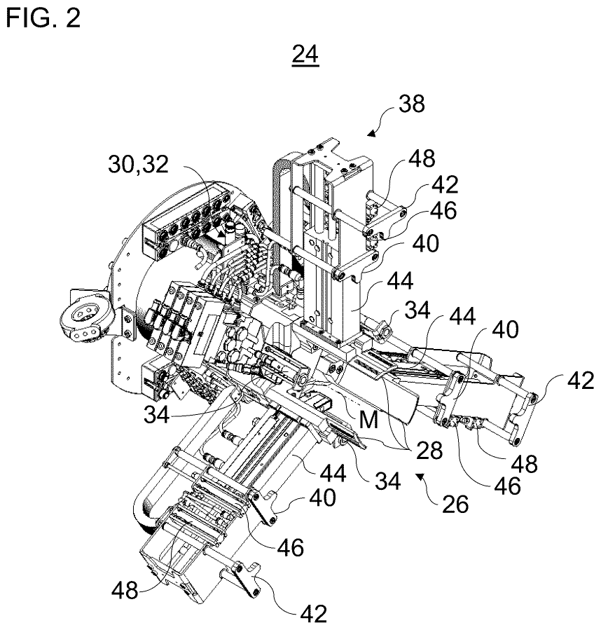

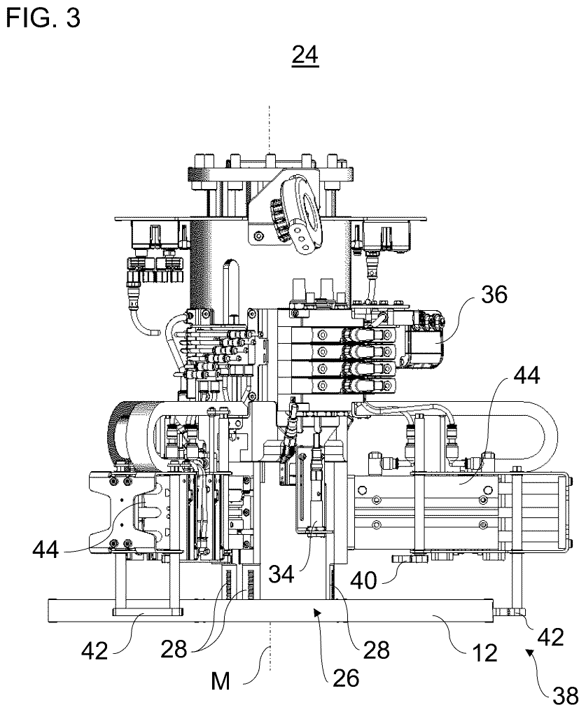

FIG. 1 shows an apparatus 10 with a robot 20, a processing device 22 (only shown schematically in FIG. 1) and a gripping system 24. FIGS. 2 and 3 show the gripping system 24 in greater detail. The apparatus 10 may preferably be included in a container treatment system.

The apparatus 10 is designed to handle a label roll 12. The apparatus 10 can pick up the label roll 12 from a roll deposit 14, move it to a roll receptacle 16 and deliver it to the roll receptacle 16. The apparatus 10 can also pick up a label roll 12 from the roll receptacle 16, move it to the roll deposit 14 and deposit it on the roll deposit 14.

The roll deposit 14 can be a pallet, as shown in FIG. 1. Alternatively, the roll deposit 14 can, for example, be a work table on which label rolls 12 can be deposited.

The roll deposit 14 can, for example, be manually refilled with label rolls 12 by a user, for example using a pallet truck or forklift. Alternatively or additionally, the label rolls can be refilled at the roll deposit 14, for example automatically by means of an automated guided vehicle (AGV).

The roll receptacle 16 can, for example, be a roll plate for picking up and unrolling the label roll 12. The roll receptacle 16 can be aligned horizontally, as shown in FIG. 1. Alternatively, the roll receptacle 16 can be aligned vertically, for example.

Preferably, the roll receptacle 16 can have a clamping shaft 18. A label roll 12 can be clamped to the roll receptacle 16 by means of the clamping shaft 18.

The clamping shaft 18 can preferably have several clamping elements for tensioning a label roll 12. The clamping elements can, for example, be movable radially with respect to a central longitudinal axis of the clamping shaft 18, e.g. can be retracted and extended. Preferably, the clamping elements are (e.g. equally) distributed around a circumference of the clamping shaft 18. The clamping elements can be spaced apart. Preferably, the clamping elements are arranged equidistant to one another and/or to the central longitudinal axis of the clamping shaft 18. The clamping elements can be designed as clamping jaws or clamping strips, for example.

The roll receptacle 16 can be connected to a labeling unit of a labeling device for supplying the labeling unit with a label tape unwound from a label roll (not shown in the figures). The labeling unit can be designed to apply labels from the label tape to containers. The labeling unit can, for example, be interchangeably coupled to and uncoupled from a periphery of the labeling device, e.g. via a quick coupling mechanism, preferably without tools. The labeling device can be rotated by means of a drive. Preferably, the labeling device can be designed as a rotary labeling device with a carousel that can be rotated by means of the drive. Containers can be held at a distance from one another on one circumference of the carousel in treatment stations and labeled using the labeling unit. Alternatively, the labeling device can, for example, be designed as a linear labeling device, e.g. with only one treatment station or with several treatment stations arranged in series next to and/or behind one another.

However, it is also possible that the roll receptacle 16 is, for example, merely a pallet or a work table or a conveyor.

The robot 20 can carry the gripping system 24 as an end effector. The robot 52 can automatically load the roll receptacle 16 with a label roll 12 from the roll stacker 14 by means of the gripping system 24.

Preferably, the robot 20 is a multi-axis robot, particularly preferably an articulated arm robot. The articulated arm robot can, for example, be a 5-axis, 6-axis, or 7-axis articulated arm robot. Other robot types are also conceivable. Preferably, the robot 20 is a stationary robot. However, it is also possible that the robot 20 is a mobile robot. The robot 20 can be an industrial robot with or without collaboration functionality.

The processing device 22 may be configured to operate the robot 20 and/or the gripping system 24. For example, the processing device 22 may operate the robot 20 to move, position and/or align the gripping system 24. For example, the processing device 22 may operate the gripping system 24 to grip (e.g., innerly and/or externally grip) a label roll 12 and to release a gripped label roll 12.

The gripping system 24 is preferably a pneumatic gripping system. The gripping system 24 is designed to grip a label roll 12 with a ring-shaped roll core. The gripping system 24 has a central axis M.

Preferably, the gripping system 24 is dimensioned and designed in such a manner that it can grip label rolls 12 with a diameter in an area between approximately 160 mm and 600 mm.

The gripping system 24 has an inner gripper 26, preferably pneumatic, and a plurality of distance sensors 34. Optionally, the gripping system 24 may also have, for example, a preferably pneumatic external gripper 38.

Preferably, the inner gripper 26 can be an inner centric gripper. The inner centric gripper can be self-centering. The inner centric gripper can close in the middle and grip the ring-shaped roll core of the label roll 12 in the middle.

Preferably, the inner gripper 26 can grip a label roll 12 by tensioning/clamping the label roll 12 from the inside on the roll core.

The inner gripper 26 has several inner clamping jaws 28. Preferably, exactly two or three inner clamping jaws 28 are included.

The inner clamping jaws 28 can, for example, be in the form of cylindrical shell segments.

The inner clamping jaws 28 can, for example, extend longitudinally, preferably parallel to the central axis M.

The inner clamping jaws 28 are arranged in a circumferential direction around the central axis M. The inner clamping jaws 28 can be arranged at a distance from one another.

Preferably, the inner clamping jaws 28 are arranged equidistant to one another and/or to the central axis M. For example, the inner clamping jaws 28 can be arranged at angles of 360°/number of inner clamping jaws to one another with respect to the central axis M.

Preferably, an arrangement of the inner clamping jaws 28 can be substantially complementary to an arrangement of the clamping elements of the clamping shaft 18 (see FIG. 1). When transferring a label roll 12 to or from the clamping shaft 18, the inner clamping jaws 28 can preferably be aligned such that they each enter a space between two clamping elements of the clamping shaft 18.

The inner clamping jaws 28 can each have a contact face for contacting the inner circumferential face of the roll core of the label roll 12. The contact faces can be directed radially outwards in relation to the central axis M. The contact faces can preferably be curved. The contact faces are preferably profiled, e.g. ribbed or serrated.

The inner clamping jaws 28 can, for example, be metallic milled parts or metallic forged parts.

The inner clamping jaws 28 can be moved radially with respect to the central axis M to grip the inside of the label roll 12 on an inner circumferential face of the ring-shaped roll core. Radial movement can preferably be achieved by means of elastic pretensioning and/or pneumatic pressurization of the inner gripper 26.

For example, the inner gripper 26 may have a pneumatic cylinder-plunger unit that is mechanically coupled to the inner clamping jaws 28 via a transmission. Preferably, an elastic element can be arranged in the cylinder to preload the plunger against the cylinder.

Alternatively, any other suitable drive for driving the radial movement of the inner clamping jaws 28 is possible.

Preferably, the inner clamping jaws 28 can be mechanically coupled to one another. For example, the inner clamping jaws 28 can move together, preferably synchronously, radially with respect to the central axis M by means of the mechanical coupling. The mechanical coupling can, for example, be designed as a positively driven transmission, preferably as a positively driven wedge-hook transmission.

Preferably, the inner clamping jaws 28 are each elastically pretensioned radially outwards with respect to the central axis M. For example, the inner gripper 26 may have an elastic element. The elastic element can bias the inner clamping jaws 28 radially outwards with respect to the central axis M, preferably by elastically biasing a plunger against a cylinder of the inner gripper 26. For example, the elastic element can be arranged in a cylinder of the inner gripper 26. The elastic element can, for example, be a spring, preferably a coil spring. The coil spring is preferably arranged coaxially to the central axis M. Preferably, the inner clamping jaws 28 can be pretensioned radially outwards in the unpressurized state (without compressed air being applied to the cylinder of the inner gripper).

It is also possible that the inner gripper 26 has a, preferably pneumatic, non-return valve 30 for holding a gripping force of the inner gripper 26 (see FIG. 2).

Preferably, the inner gripper 26 has a function for adjusting the gripping force or clamping force. For example, the inner gripper 26 may have a pressure control valve 32. The pressure control valve 32 can be a pneumatic pressure control valve (see FIG. 2).

The pressure control valve 32 can preferably adjust the gripping force by adapting a counterforce to the elastic pretension of the inner clamping jaws 28 caused by the elastic element. For example, the tension force can be reduced for narrow label rolls 12. The elastic element for pretensioning the inner clamping jaws 28 can be adapted accordingly to the heaviest possible label roll 12.

Alternatively, the pressure control valve 32 can adjust the gripping force, for example by adjusting a supporting force to the elastic pretension of the inner clamping jaws 28 caused by the elastic element. In this case, the elastic element for pretensioning the inner clamping jaws 28 can be designed to be weaker than in the previous case. The heaviest possible label roll 12 can then, for example, only be held under low dynamic forces or at a standstill. In production mode, the gripping force can then be increased accordingly by applying compressed air to the cylinder of the inner gripper 26. This compressed air supply can optionally be adapted to the corresponding label roll type by means of the pressure control valve 32.

Preferably, the gripping force/clamping force of the inner gripper 26 can be adapted to a material of the roll core of the label roll 12 by means of the pressure control valve 32. For example, the processing device 22 can adjust an operation (a position) of the pressure control valve 32 depending on a predetermined material of the roll core. For example, a plastic roll core may require a greater gripping force than a cardboard roll core.

It is possible for the pressure control valve 32 to be manually or automatically configurable (adjustable). For example, the processing device 22 may be configured to adjust the pressure control valve 32 depending on a desired gripping force of the inner gripper 26 and/or depending on a predetermined weight of the label roll 12 and/or depending on a material of the roll core of the label roll 12.

The at least one distance sensor 34 is arranged to detect a distance between the gripping system 24 and the label roll 12. Preferably, the at least one distance sensor 34 can be aligned parallel to the central axis M.

More specifically, each distance sensor 34 can preferably detect a distance between a side (top side) of the label roll 12 facing the gripping system 24 and the respective distance sensor 34.

Preferably, the at least one distance sensor 34 can detect both a distance to the rolled-up label tape of the label roll 12 and a distance to the roll core of the label roll 12. Since the label tape can protrude over the roll core, damage to the label tape can be prevented by taking into account the different distances detected when positioning the gripper system 24 by means of the processing device 22. If, on the other hand, only the distance to the roll core was detected and taken into account, for example, there would be a risk of the inner clamping jaws being pushed too far into the label roll 12.

The at least one distance sensor 34 can, for example, be designed as an ultrasonic sensor, a diffuse sensor, a laser sensor or a capacitive sensor or similar.

Preferably, a plurality of distance sensors 34, e.g. exactly two or three distance sensors 34, are included. The distance sensors 34 can preferably be arranged distributed in a circumferential direction around the central axis M. Preferably, the distance sensors 34 and the inner clamping jaws 28 can alternate in a circumferential direction around the central axis M.

For example, the distance sensors 34 can be arranged equidistant to the central axis M and/or to one another. For example, distance sensors 34 can be arranged at angles of 360°/number of distance sensors to one another with respect to the central axis M.

Preferably, the processing device 22 can operate the robot 20 to position the gripping system 24 to grip the label roll 12 by means of the inner gripper 26 depending on the sensed distance or distances. Preferably, the inner gripper 26 can thus be positioned at a relatively precise distance from the label roll 12.

Optionally, the positioning of the gripping system 24 can also be dependent on a thickness (height) of the label roll 12. Preferably, an immersion depth of the inner gripper 26 in the roll core can be adjusted depending on the thickness of the label roll 12. The thickness can, for example, be specified via a known, recorded or predefined type parameter of the label roll 12. Alternatively, the thickness can be detected, for example, by means of a camera 36 (see FIG. 3).

Preferably, by considering the thickness, the clamping length along the central axis M can be optimized or maximized without the risk of the inner clamping jaws 28 protruding beyond the roll core. For example, a very narrow label roll 12 can be picked up from a stack without damaging or displacing the label roll 12 underneath. If the label roll 12 is wide or thick and therefore heavy, the inner clamping jaws 28 can be moved further into the roll core to ensure that the label roll 12 is securely clamped.

Preferably, the gripping system 24 can also have an alignment function. For example, the processing device 22 may further be configured to determine an orientation of the label roll 12 relative to the gripping system 24 depending on the distances sensed by the plurality of distance sensors 34. The robot 20 can then be operated to align the gripping system 24 for gripping the label roll 12 by means of the inner gripper 26 furthermore depending on the determined alignment. Preferably, the inner clamping jaws 28 can thus be aligned parallel to the roll core of the label roll 12 so that the label roll 12 can be gripped particularly securely and centrally.

For example, the distance between the gripping system 24 and the label roll 12 can be detected at several, e.g. three, points. This detection can preferably be carried out by several, e.g. three, distance sensors 34 arranged evenly around the circumference. Alternatively, the measurement can be carried out using only one distance sensor 34, which can be moved by the robot 20 to several, e.g. three, different measuring positions.

The processing device 22 may be configured to calculate an inclination of the gripping system 24 with respect to the label roll 12 from the distance detected at the plurality of locations. The processing device 22 may be configured to compensate (level) this inclination of the robot 20 by adjusting a pose of the gripping system 24.

The optical camera 36 may be a part of the gripping system 24, as exemplified in FIG. 3. Alternatively, the camera 36 can, for example, be carried directly by the robot 20. The camera 36 can be a 2D or 3D camera, for example.

The camera 36 is designed to record the label roll 12. Depending on a recording of the camera 36, the processing device 22 can, for example, determine a position of the label roll 12 on the roll deposit 14 and operate the robot to position the gripping system 24 for gripping the label roll 12. It is also possible that the positions of several label rolls 12 within a roll stack are determined from a recording of the camera 36 and the determined positions are taken into account for positioning the gripping system 24.

For example, depending on the recording of the camera 36, a pre-positioning of the gripping system 24 relative to the label roll 12 can be performed. The distances detected by the distance sensors 34, for example, can then be taken into account for fine positioning.

It is also possible that a distance and/or an orientation between the gripping system 24 and the label roll 12 is determined from a (e.g. 3D) recording of the camera 36.

It is also possible that the apparatus 10 can automatically align itself with respect to the roll receptacle 16 and/or the clamping shaft 18 by means of the distance sensors 34 and/or the camera 36.

The outer gripper 38 can secure the already innerly gripped label roll 12 to an outer circumferential face of the label roll 12. Preferably, the maximum gripping force that can be exerted by the outer gripper 38 can be less than the maximum gripping force that can be exerted by the inner gripper 26.

The outer gripper 38 may have a plurality of outer clamping jaws 40, 42, a plurality of radial lift cylinders 44 and/or a plurality of axial lift cylinders 46, 48.

The outer clamping jaws 40, 42 are used to secure the label roll on the outside. The outer clamping jaws 40, 42 can be movable radially with respect to the central axis M to secure the label roll 12 on an outer circumferential face of the label roll 12.

The outer clamping jaws 40, 42 can preferably be designed for gentle outer clamping of the label roll 12. For example, the outer clamping jaws 40, 42 can be rounded. The outer clamping jaws 40, 42 can be made of an elastically compressible material. The outer clamping jaws 40, 42 can be made of a softer material than the inner clamping jaws 28.

The outer clamping jaws 40, 42 can be T-shaped or rod-shaped, for example. Preferably, the outer clamping jaws 40, 42 can be aligned radially towards the central axis M.

The outer clamping jaws 40, 42 can be arranged on the outside of the inner clamping jaws 28 in a circumferential direction around the central axis M. Preferably, several first (inner) outer clamping jaws 40 and several second (outer) outer clamping jaws 42 are included.

The first outer clamping jaws 40 can be arranged on the outside of the inner clamping jaws 28 in a circumferential direction around the central axis M, preferably equidistant to one another and/or to the central axis M. For example, the first outer clamping jaws 40 can be arranged at angles of 360°/number of first outer clamping jaws to one another with respect to the central axis M.

The second outer clamping jaws 42 can be arranged on the outside of the first outer clamping jaws 40 in a circumferential direction around the central axis M, preferably equidistant to one another and/or to the central axis M. For example, the second outer clamping jaws 42 can be arranged at angles of 360°/number of second outer clamping jaws to one another with respect to the central axis M.

The first and second outer clamping jaws 40, 42 together with their lift cylinders 44 and possibly 46, 48 can enable a very large clamping range. The first outer clamping jaws 40 can externally secure label rolls 12 with a smaller diameter than the label rolls 12 that the second outer clamping jaws 42 can externally secure.

For example, the first outer clamping jaws can secure 40 label rolls 12 with a diameter of between approximately 160 mm and 380 mm on the outside. The second outer clamping jaws 42 can, for example, secure label rolls 12 with a diameter of between approximately 380 and 600 mm on the outside.

The radial lift cylinders 44 are used to apply the clamping force to the outer circumferential face of the label roll 12 via the outer clamping jaws 40, 42.

In detail, the radial lift cylinders 44 can be connected to the outer clamping jaws 40, 42 and move them radially with respect to the central axis M. Preferably, one of the radial lift cylinders 44 can be connected to each of the first outer clamping jaws 40 and one of the second outer clamping jaws 42 for radial movement of these two outer clamping jaws 40, 42.

The outer gripper 38 may be externally mounted, preferably bolted, to the plurality of inner clamping jaws 28. For example, one of the radial lift cylinders 44 can be mounted, preferably screwed, on the outside of one of the inner clamping jaws 28, e.g. on the front side. This allows the outer clamping jaws 40, 42 to be mechanically coupled to the inner clamping jaws 28 for radial movement with respect to the central axis M with the inner clamping jaws 28. By extending and retracting the radial lift cylinders 44, the outer clamping jaws 40, 42 can then also be moved radially with respect to the central axis M independently of the multiple inner clamping jaws 28.

Preferably, the outer clamping jaws 40, 42 can also be movable parallel to the central axis M, preferably retractable and extendable. Specifically, the axial stroke cylinders 46, 48 can be connected to the outer clamping jaws 40, 42 and move the outer clamping jaws 40, 42 parallel to the central axis M. Preferably, one of the axial lift cylinders 46, 48 is connected to each of the outer clamping jaws 40, 42 for moving these outer clamping jaws 40, 42 parallel to the central axis M.

Preferably, a plurality of first (inner) axial lift cylinders 46 and a plurality of second (outer) axial lift cylinders 48 are included.

The first axial lift cylinders 46 can be arranged radially inwards of the second axial lift cylinders 48 with respect to the central axis M. The first axial stroke cylinders 46 can be arranged distributed in a circumferential direction around the central axis M, preferably equidistant from one another and/or from the central axis M. The second axial stroke cylinders 28 can be arranged distributed in a circumferential direction around the center axis M, preferably equidistant from one another and/or from the central axis M.

The first axial lift cylinders 46 may be connected to the first outer clamping jaws 40 for axially moving the first outer clamping jaws 40 parallel to the central axis M. The second axial lift cylinders 48 may be connected to the second outer clamping jaws 42 for axially moving the second outer clamping jaws 42 parallel to the central axis M.

When extending and retracting the axial lift cylinders 46, 48, the outer clamping jaws 40, 42 can preferably each be guided on at least one guide pillar.

The axial lift cylinders 46, 48 can be connected between the several radial lift cylinders 44 and the outer clamping jaws 40, 42. Preferably, the plurality of radial lift cylinders 44 for radially moving the axial lift cylinders 46, 48 together with the outer clamping jaws 40, 42 can be connected to the axial lift cylinders 46, 48 with respect to the central axis M.

For example, one of the radial lift cylinders 44 can be connected to two of the axial lift cylinders 46, 48 (e.g. one of the first axial lift cylinders 46 and one of the second axial lift cylinders 48) for radial movement of these two axial lift cylinders 46, 48. Preferably, two axial lift cylinders 46, 48 can be mounted on each radial lift cylinder 44.

For example, a method for handling the label roll 12 may have the following steps.

To pick up a label roll 12, the label roll 12 can first be gripped at an inner circumferential face of the roll core by means of the inner clamping jaws 28 of the inner gripper 26. The innerly gripped label roll 12 can then be secured to an outer circumferential face of the label roll 12 by means of the plurality of outer clamping jaws 40 or 42. For external securing, the external clamping jaws 40 or 42 can first be extended by means of the axial lift cylinders 46 or 48. Then the outer clamping jaws 40 or 42 can be moved radially inwards to the central axis M by means of the radial lift cylinders 44 until a desired outer clamping on the outer circumferential face of the label roll 12 is achieved.

Preferably, the outer gripper 38 can be designed in such a way that, in the retracted state of the axial lift cylinders 46, 48, an interference contour caused by the outer clamping jaws 40, 42 is smaller than an outer diameter of a label roll of 550-600 mm.

Preferably, the radial lift cylinders 44 may each have a displacement sensor, preferably an analog sensor. The processing device 22 can determine, for example, a diameter of a label roll 12 secured on the outside by means of the outer clamping jaws 40 or 42, depending on a signal output of the displacement measuring sensors.

Preferably, the determined diameter can be compared with a nominal diameter of the label roll 12 for recognizing a correct positioning of the several outer clamping jaws 40, 42.

It is also possible for the diameter to be determined several times in succession for the same label roll 12 in order to detect (undesired) telescoping of the label roll 12 when the diameter is reduced.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1 and, for example, independently of the features relating to the presence and/or configuration of the inner gripper, the inner clamping jaws and/or the at least one distance sensor of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 apparatus for handling label rolls
12 label roll
14 roll deposit
16 roll receptacle
18 clamping shaft
20 robot
22 processing device
24 gripping system
26 inner gripper
28 inner clamping jaw
30 non-return valve
32 pressure control valve
34 distance sensor
36 camera
38 outer gripper
40 outer clamping jaw
42 outer clamping jaw
44 radial lift cylinder
46 axial lift cylinder
48 axial lift cylinder
M Central axis

What is claimed is:

1. A gripping system for gripping a label roll having an annular roll core, wherein the gripping system has:
an inner gripper having a plurality of inner clamping jaws which are arranged distributed in a circumferential direction around a central axis of the gripping system and are movable radially with respect to the central axis for gripping the label roll on an inner circumferential face of the annular roll core; and
at least one distance sensor, which is arranged for detecting a distance between the gripping system and the label roll.

2. The gripping system according to claim 1, wherein at least one of:
the at least one distance sensor has a plurality of distance sensors which are arranged distributed in a circumferential direction around the central axis; and
the at least one distance sensor is aligned parallel to the central axis.

3. The gripping system according to claim 1, wherein at least one of:
the plurality of inner clamping jaws are mechanically coupled to one another for joint radial movement; and
the plurality of inner clamping jaws each have a contact face for contacting the inner circumferential face of the roller core, wherein the contact faces are profiled.

4. The gripping system according to claim 1, wherein at least one of:
the plurality of inner clamping jaws are each elastically biased radially outwards with respect to the central axis;
the inner gripper has a pressure control valve for adjusting a gripping force of the inner gripper; and
the inner gripper has a non-return valve for holding a gripping force of the inner gripper.

5. The gripping system according to claim 1, wherein at least one of:
the inner gripper is pneumatic;
the inner gripper is an inner centric gripper;
the plurality of distance sensors are arranged distributed in a circumferential direction around the central axis alternately with the plurality of inner clamping jaws;
the plurality of inner clamping jaws are mechanically coupled to one another for joint synchronous radial movement via a positively driven transmission;
the plurality of inner clamping jaws are mechanically coupled to one another for joint synchronous radial movement via a positively driven wedge-hook transmission;
the contact faces are profiled one of corrugated and serrated;
the pressure control valve is pneumatic;
the inner gripper has a pressure control valve for adjusting a gripping force of the inner gripper by adjusting one of a counterforce and supporting force to an elastic bias of the plurality of inner clamping jaws; and
the non-return valve is pneumatic.

6. The gripping system according to claim 1, wherein:
the gripping system further has an outer gripper with a plurality of outer clamping jaws, which are arranged on the outside of the plurality of inner clamping jaws in a circumferential direction around the central axis and are movable radially with respect to the central axis for securing the label roll on an outer circumferential face of the label roll.

7. The gripping system according to claim 6, wherein at least one of:
the plurality of outer clamping jaws are mechanically coupled to the plurality of inner clamping jaws for radial movement with respect to the central axis with the plurality of inner clamping jaws and the outer clamping jaws are additionally movable radially with respect to the central axis independently of the plurality of inner clamping jaws;
the outer gripper is mounted externally on the plurality of inner clamping jaws; and the plurality of outer clamping jaws are movable parallel to the central axis.

8. The gripping system according to claim 6, wherein:
the plurality of outer clamping jaws have a plurality of first outer clamping jaws and a plurality of second outer clamping jaws,
the plurality of first outer clamping jaws are arranged externally of the plurality of inner clamping jaws in a circumferential direction around the central axis, and
the plurality of second outer clamping jaws are arranged on the outside of the plurality of first outer clamping jaws in a circumferential direction around the central axis.

9. The gripping system according to claim 6, wherein:
the outer gripper has a plurality of radial lift cylinders which are connected to the outer clamping jaws for radially moving the plurality of outer clamping jaws with respect to the central axis.

10. The gripping system according to claim 6, wherein at least one of:
the outer gripper is pneumatic;
the plurality of outer clamping jaws are at least one of rounded, made of an elastically compressible material, and made of a softer material than the inner clamping jaws;
the maximum gripping force that can be exerted by the outer gripper is less than the maximum gripping force that can be exerted by the inner gripper;
the plurality of outer clamping jaws are retractable and extendable parallel to the central axis;
one each of the plurality of radial lift cylinders is mounted externally on each of the plurality of internal clamping jaws;
the plurality of radial lift cylinders each have a displacement sensor; and
one each of the plurality of radial lift cylinders is connected to two each of the outer clamping jaws for the radial movement of the two outer clamping jaws.

11. The gripping system according to claim 6, wherein:
the outer gripper has a plurality of axial lift cylinders which are connected to the outer clamping jaws for axially moving the plurality of outer clamping jaws parallel to the central axis.

12. The gripping system according to claim 11, wherein:
the plurality of radial lift cylinders are connected to the plurality of axial lift cylinders for radially moving the plurality of axial lift cylinders together with the outer clamping jaws with respect to the central axis.

13. The gripping system according to claim 11, wherein at least one of:
one each of the plurality of axial lift cylinders is connected to each of the outer clamping jaws for axially moving one of the outer clamping jaws;
one each of the plurality of radial lift cylinders is connected to two each of the plurality of axial lift cylinders for radially moving the two axial lift cylinders; and
the multiple axial lift cylinders are connected between the plurality of radial lift cylinders and the outer clamping jaws.

14. An apparatus for handling a label roll having an annular roll core, wherein the apparatus has:
a gripping system according to claim 1;
a robot that carries the gripping system as an end effector; and
a processing device configured to operate the robot for positioning the gripping system for gripping the label roll via the inner gripper depending on a distance between the label roll and the gripping system detected by the at least one distance sensor.

15. The apparatus according to claim 14, wherein:
the at least one distance sensor has a plurality of distance sensors; and
the processing device is further configured to:
determine an orientation of the label roll relative to the gripping system depending on the distances detected by the plurality of distance sensors, and
operate the robot for aligning the gripping system for gripping the label roll via the inner gripper furthermore in dependence on the determined alignment for gripping the label roll.

16. The apparatus according to claim 14, wherein:
one of the gripping system and the robot has a camera for recording the label roll, and the processing device is further configured to at least one of:
determine a position of the label roll depending on a recording of the camera and to operate the robot for positioning the gripping system for gripping the label roll via the inner gripper depending on the determined position; and
determine positions of a plurality of label rolls within a roll stack depending on a recording of the camera and to operate the robot for positioning the gripper system for gripping a respective uppermost label roll of the roll stack via the inner gripper depending on the determined positions.

17. The apparatus according to claim 14, wherein:
the gripping system further has an outer gripper with a plurality of outer clamping jaws, which are arranged on the outside of the plurality of inner clamping jaws in a circumferential direction around the central axis and are movable radially with respect to the central axis for securing the label roll on an outer circumferential face of the label roll,
the outer gripper has a plurality of radial lift cylinders which are connected to the outer clamping jaws for radially moving the plurality of outer clamping jaws with respect to the central axis,
the plurality of radial lift cylinders each have a displacement sensor, and
the processing device is further configured to determine a diameter of a label roll secured on the outside via the outer clamping jaws depending on a signal output of the displacement measuring sensors.

18. The apparatus according to claim 14, wherein at least one of:
the robot is stationary;
the robot is a multi-axis robot;
the robot is an articulated arm robot;
the processing device is further configured to operate the robot for positioning the gripping system for gripping the label roll via the inner gripper further in dependence on one of a detected and predetermined thickness of the label roll;
the processing device is further configured to operate the robot for positioning the gripping system for gripping the label roll via the inner gripper further in dependence on one of a detected and predetermined thickness of the label roll for adapting an immersion depth of the inner gripper into the roll core depending on the thickness;
the processing device is further configured to operate the robot for aligning the gripping system for gripping the label roll via the inner gripper in dependence on the determined alignment for gripping the label roll;
the processing device is further configured to operate the robot for aligning the gripping system for gripping the label roll via the inner gripper in dependence on the determined alignment for aligning the plurality of inner clamping jaws parallel to the roll core for gripping the label roll;
one of the gripping system and the robot has a camera, that is one of a 2D camera and a 3D camera, for recording the label roll;
the gripping system has a pneumatic outer gripper with a plurality of outer clamping jaws arranged on the outside of the plurality of inner clamping jaws in a circumferential direction around the central axis;
the processing device is further configured to compare the determined diameter with a nominal diameter of the label roll to detect correct positioning of the multiple outer clamping jaws; and
the processing device is further configured to determine the diameter several times in succession for the same label roll to detect telescoping of the label roll when the diameter is reduced.

19. A method of operating a gripping system according to claim 1, wherein the method has:
detecting at least one distance between the gripping system and a label roll via the at least one distance sensor;
at least one of positioning and aligning the inner gripper to an annular roll core of the label roll as a function of the at least one detected distance; and
innerly gripping the label roll on an inner circumferential face of the roll core via the plurality of inner clamping jaws of the inner gripper after at least one of positioning and aligning.

20. The method of claim 19 further comprising at least one of:
the at least one of positioning and aligning the inner gripper to an annular roll core of the label roll as a function of the at least one detected distance is via a robot;
the innerly gripping the label roll on an inner circumferential face of the roll core via the plurality of inner clamping jaws of the inner gripper after at least one of positioning and aligning is effected by an elastic pretension of the plurality of inner clamping jaws;
securing the internally gripped label roll to an outer circumferential face of the label roll via a plurality of outer clamping jaws of an outer gripper of the gripping system;
adjusting a gripping force of the inner gripper via a pressure control valve;
adjusting the gripping force of the inner gripper via a pneumatic pressure control valve;
aligning the inner gripper with a clamping shaft of a roll receptacle during a label roll transfer between the inner gripper and the clamping shaft; and
aligning the inner gripper with a clamping shaft of a roll receptacle during a label roll transfer between the inner gripper and the clamping shaft in such a way that the plurality of inner clamping jaws can penetrate into spaces between clamping elements of the clamping shaft.
